(19) United States
(12) Patent Application Publication
(10) Pub. No.: US 2007/0065338 A1
(43) Pub. Date: Mar. 22, 2007

(54) Testing strip and dispenser

(76) Inventors: Jerry Schindler, Acworth, GA (US); Bobby Edward Butler, Marietta, GA (US)

Correspondence Address: FILDES & OUTLAND. P.C., Suite 2, 20916 Mack Avenue, Grosse Pointe Woods, MI, 48236, US

(21) Appl. No.: 11/516,242

(22) Filed: Sep. 6, 2006

Related U.S. Application Data
(60) Provisional application No. 60/714,384, filed on Sep. 6, 2005.

(51) Int. Cl. G01N 31/22

(52) U.S. Cl. 422/56

(57) ABSTRACT

A testing strip includes an elongated strip carrier and a reagent on the carrier. The reagent reacts with one of Rohypnol, Ketamine, GHB, GBL, and 1,4-butanediol to change color indicating the presence of Rohypnol, Ketamine, GHB, GBL, and 1,4-butanediol. A dispenser for dispensing testing strips is also disclosed. The dispenser includes a container and at least one testing strip including an elongated strip carrier and a reagent on the carrier that reacts with one of Rohypnol, Ketamine, GHB, GBL, and 1,4-butanediol to change color indicating the presence of Rohypnol, Ketamine, GHB, GBL, and 1,4-butanediol.

### CROSS REFERENCE TO RELATED APPLICATION

This application claims the benefit of U.S. Provisional Application No. 60/714,384, filed Sep. 6, 2005.

### TECHNICAL FIELD

This invention relates to testing strips, and more particularly to testing strips to test for the presence of chemicals and dispensers for dispensing the testing strips.

### BACKGROUND OF THE INVENTION

Drug facilitated sexual assault has been shown to be increasing among the adolescent and young adult population. Sexual assaults have been perpetrated on both men and women while these victims are incapacitated by chemical substances known as date rape drugs. These date rape drugs act rapidly in the human body, often within 20 minutes of ingestion, causing physical and psychological symptoms such as disinhibition, muscle relaxation, passivity, and loss of will to resist. These symptoms can last for up to 12 hours. Also, alcoholic beverages can enhance the effects of these substances.

The victim, upon restoration of consciousness, may have multiple symptoms, including drowsiness, dizziness, impaired memory, confusion, and reduced inhibition. The victim may also later describe having experienced strange sensations of being paralyzed, being unable to resist, and a having dissociation of mind and body, if any memory of the event remains.

The top five drugs used in drug facilitated sexual assault are Rohypnol, Ketamine, GHB (Gamma-Hydroxybutyrate), GBL (Gamma Butyrolactone), and 1,4-butanediol. Rohypnol, also known as Flunitrazepam, has the chemical formula 5-(2-fluorophenyl)-1,3,dihydro-1 methyl-7 nitro-2H-1,4-benzodizepin-2-one. Rohypnol has been known to be in use as a date rape drug since the early 1990s. The hypnotic effects of Rohypnol predominate over its sedative effects, and Rohypnol is ten times as potent as Valium.

Ketamine, a cousin of PCP, was introduced in the 1960s as an anesthetic and is now used commonly be veterinarians when performing surgeries. The chemical formula of Ketamine is C₁₃H₁₆CINO. It is also produced under the brand names of Ketajet, Ketaset, and Ketelar.

GHB (Gamma-Hydroxybutyrate), which has the chemical formula C₄H₈O₃, is a naturally occurring metabolite of GABA, which is thought to function as a neurotransmitter. GHB has been used to enhance muscle strength and increase the release of growth hormone. It has also been used as a CNS (central nervous system) depressant. GHB has several chemical precursors, two of which are GBL and 1,4-butanediol.

GBL (Gamma Butyrolactone) is a commercially available solvent found in most floor strippers and pine needle oil. When ingested, it is converted to GHB. In the year 2000, approximately 140 million pounds of GBL was produced.

1,4-butanediol, having the chemical formula C₄H₁₀O₂, is also converted to GHB when ingested. 1,4-butanediol is commonly used as an industrial degreaser and in the making of plastics. More than 800 million pounds were produced in the year 2000.

These substances, collectively known as date rape drugs, were not originally intended for the purposes that now seem prevalent. All of these substances have been or still are used for legitimate and productive purposes. Rohypnol has been used to treat severe sleep disorders. Ketamine was used during the Vietnam War as an anesthetic and pain reliever and is still in use today. GHB has also been used for sleep disorders as well as to enhance muscle strength. GBL and 1,4-butanediol, though not manufactured for use in the human body, have been used in the production of plastics, textiles, and cleaning supplies. These date rape drugs, which can act in as little as 20 minutes and have effects lasting up to 12 hours, have been increasing in use.

One common method date rape perpetrators use to drug a victim is by putting a date rape drug into the victim's drink unbeknownst to the victim. Some perpetrators are able to introduce a drug into a drink quickly and without the appearance of wrongdoing. These factors have made it increasingly more dangerous to consume beverages in social settings such as bars and restaurants, or even as a guest in someone's residence. As the public has become more aware of drug facilitated sexual assaults, there has become an increased need for a product that can help prevent these victimizations.

### SUMMARY OF THE INVENTION

The present invention provides a testing strip as well as a dispenser for storage, transportation, and dispensing of the testing strips. The testing strip allows for the determination of the presence of a date rape drug so as to prevent the undesired ingesting of date rape drugs. The testing strip also advantageously allows for the testing of the presence of one or more date rape drugs on a single testing strip.

In one embodiment, a testing strip in accordance with the invention includes an elongated strip carrier and a reagent on the carrier. The reagent reacts with one of Rohypnol, Ketamine, GHB, GBL, and 1,4-butanediol to change color indicating the presence of Rohypnol, Ketamine, GHB, GBL, and 1,4-butanediol.

Optionally, the elongated strip carrier may be made of plastic, cellulose paper, or similar. The reagent may be impregnated in, coated on, or adhered to the elongated strip carrier.

A dispenser for dispensing testing strips in accordance with the invention includes a container and at least one of the testing strips comprising an elongated strip carrier and a reagent on the carrier. The reagent reacts with one of Rohypnol, Ketamine, GHB, GBL, and 1,4-butanediol to change color indicating the presence of Rohypnol, Ketamine, GHB, GBL, and 1,4-butanediol. The dispenser may also include a mechanism for releasing one of the testing strips from the container.

These and other features and advantages of the invention will be more fully understood from the following detailed description of the invention taken together with the accompanying drawings.

### BRIEF DESCRIPTION OF THE DRAWINGS

In the drawings:

FIG. 1 is a rear view of a testing strip dispenser in accordance with the present invention;

FIG. 2 is a top view of the testing strip dispenser of FIG. 1;

FIG. 3 is a side view of the testing strip dispenser of FIG. 1;

FIG. 4 is a perspective elevational sectional view of another embodiment of a testing strip dispenser;

FIG. 5 is a perspective view of a testing strip dispenser in accordance with the invention;

FIG. 6 is a plan view of the testing strip dispenser of FIG. 5;

FIG. 7 is an elevational sectional view of a testing strip dispenser;

FIG. 8 is a perspective end view of another testing strip dispenser;

FIG. 9 is an elevational end view of a testing strip dispenser;

FIG. 10 is a plan view of an end of a testing strip dispenser;

FIG. 11 is a perspective view of stacked plurality of testing strips having triangular cross-sectional shape;

FIG. 12 is a side elevational view of stacked plurality of testing strips of FIG. 11;

FIG. 13 illustrates views of a testing strip having triangular cross-sectional shape;

FIG. 14 illustrates views of a testing strip having channels for multiple reagents; and

FIG. 15 illustrates views of a testing strip for multiple reagents.

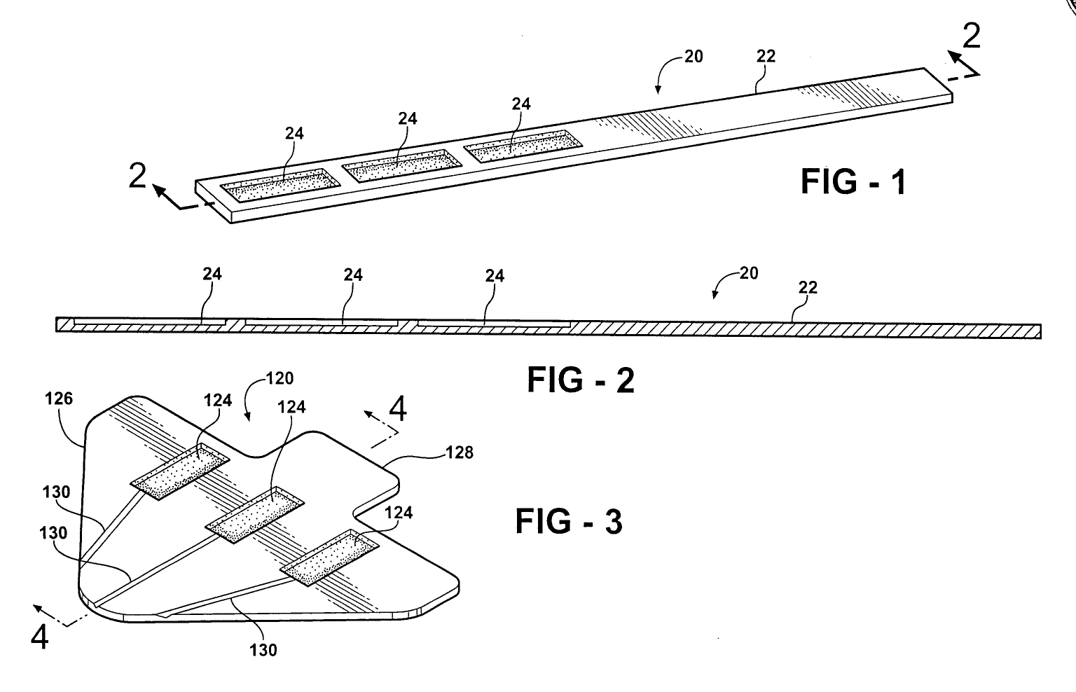

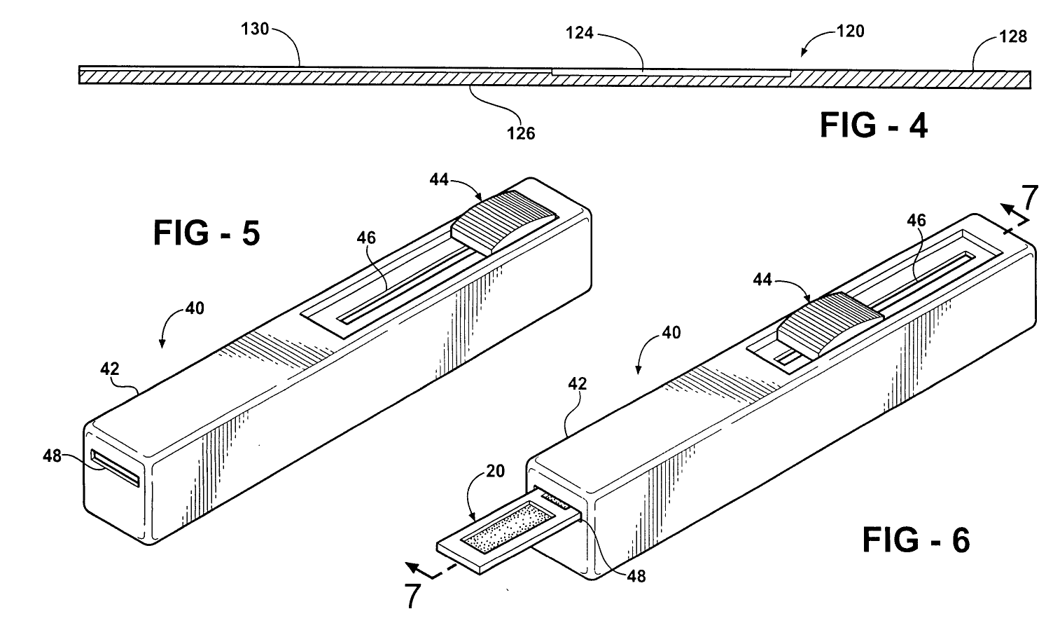

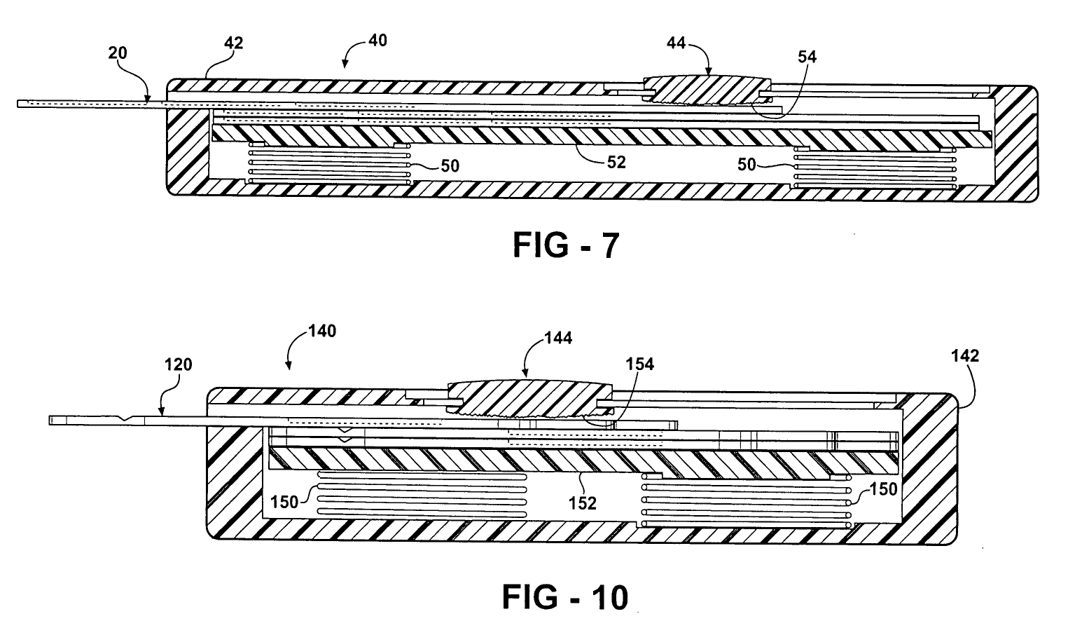

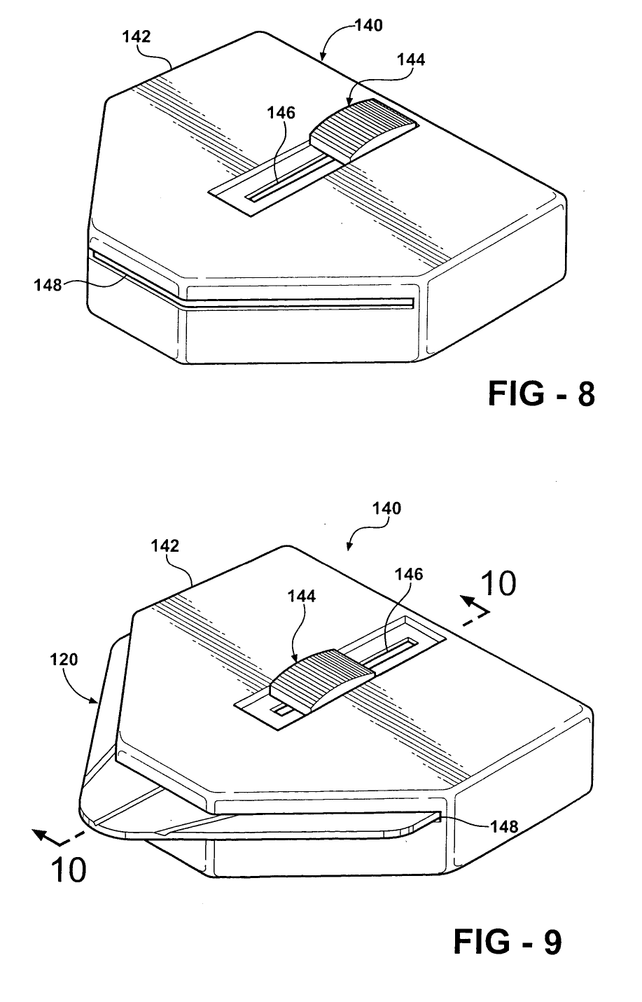

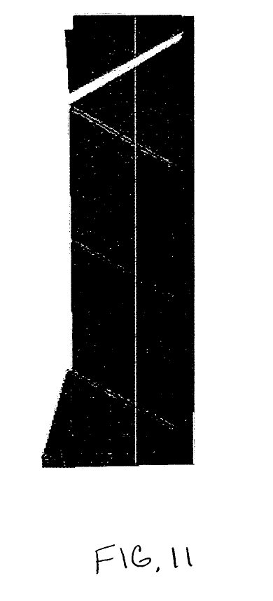

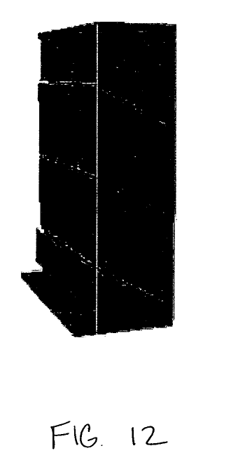

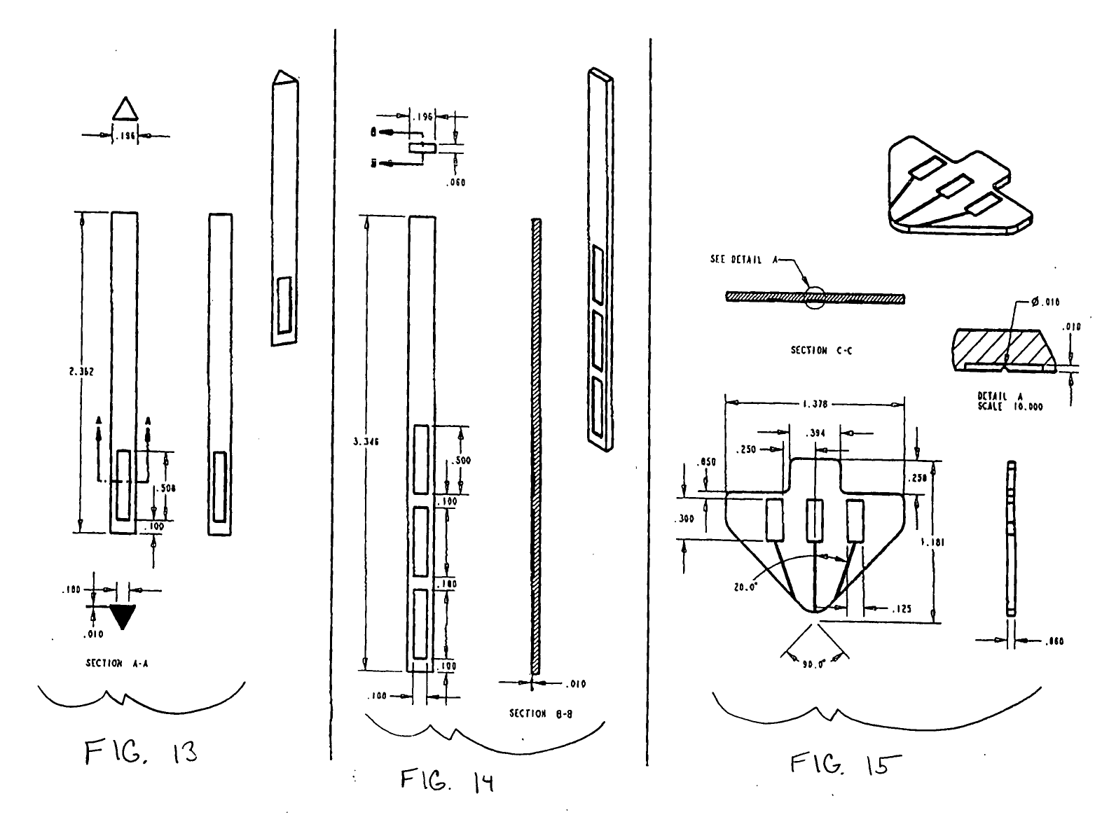

### DETAILED DESCRIPTION OF THE INVENTION

The testing strip includes an elongated strip carrier and a reagent on the carrier. The reagent reacts with one of Rohypnol, Ketamine, GHB, GBL, and 1,4-butanediol to change color indicating the presence of Rohypnol, Ketamine, GHB, GBL, and 1,4-butanediol.

More particularly, the elongated strip carrier may be approximately 2 to 3 inches in length and approximataly ⅛ to 3/16 of an inch in width. It should be understood, however, that the testing strip may be any other dimensions. Generally, the testing strip may be longer than it is wide to allow for easy dipping of the testing strip into a liquid.

Alternatively, the strip carrier may be approximately 6 cm long with three distinct sides, thereby forming an elongated triangular shape. Each side may be approximately 0.3 cm wide. A reagent may be disposed on each of the three sides.

In yet another embodiment, the strip carrier may be approximately 8.5 cm in length and 0.5-2.5 cm wide. One or more reagents may be disposed on one side of the carrier. The carrier may also include an upper portion where no reagent is present to allow a user to grip and hold the carrier.

In a further alternative embodiment, the strip carrier may be approximately 3.5 cm wide and 3 cm in height, with an approximately 1 cm by 1 cm tab at an upper end for gripping and holding the carrier. One or more reagents may be disposed on one side of the carrier. The carrier may also optionally include a siphoning feature that aids in drawing a fluid being tested to the reagents on the carrier.

The testing strip may also be dual sided. An indicator to test for acid may be present on one side of the strip or a base may be present on the other side of the strip. The indicator(s) allows a user to determine which side of the testing strip will be read for positive identification of the presence of the date rape drug(s). The testing strip is therefore capable of testing for the presence of date rape drugs in both acidic and basic liquid solutions. The indicator may be on the testing strip. For instance, on the “acidic” side of the testing strip, the indicator is sensitive to acids and indicates if a solution is acidic. Similarly, on the “basic” side of the testing strip, the indicator is sensitive to bases and indicates if a solution is basic. In this case, the indicator on each side of the testing strip is different, though it is equally possible that the same indicator could be used on both sides and that the indicator reacts to both acids and bases, albeit in a different way (i.e., by turning different colors). When a user dips the testing strip into a fluid (e.g., a beverage) and then removes the testing strip, the user will know whether the fluid is an acid or a base by observing the indicator(s). If the solution is an acid, the user should read the “acid” side of the testing strip for results of the chemical test (see below), and if the solution is a base, the user should read the “base” side of the testing strip.

The carrier strip may be made of a plastic material or may be made of a cellulose paper material, although the carrier strip is not limited to these materials. Use of a cellulose paper material is advantageous because the cellulose paper is pH neutral and easily binds proteins and other chemicals to it.

The testing strip is capable of testing for the presence of one or more chemical substances. For example, in a specific embodiment, the testing strip can test for the presence of the date rape drugs Rohypnol (Flunitrazepam), Ketamine, GHB (Gamma Hydroxybutyrate), GBL (Gamma Butyrolactone), and 1,4-butanediol. This makes the testing strip very efficient to use. It is possible for the testing strip to test for the presence of fewer or more chemical substances as well other chemical substances not specifically discussed herein.

To use the testing strip, the strip may be submerged into a beverage or other liquid and then removed. Within about 30 seconds, the testing strip will produce results, indicating a positive for each date rape drug that is present in the beverage. As such, the testing strip can quickly and easily reveal the presence of a date rape drug. Therefore, a person can quickly and easily ascertain whether a beverage is safe to consume.

The reagent on the strip carrier may be cobalt, a Marquis reagent, a Mandelin reagent, or a similar reagent. The reagent may be impregnated in, coated on, or adhered to the carrier. When the reagent is in the presence of a date rape drug, it will react with the date rape drug to produce a change in color. For example, when cobalt ions in a water solution react with GHB, a blue color may appear. In contrast, a Mandelin or Marquis reagent reacts with GHB to produce a green color.

Further, when a Mandelin reagent is reacted with Rohypnol, a brown/orange color may appear. Vanadate along with sulfuric acid may be used to catalyze this reaction. The color appears after Vanadate is oxidized. In contrast, when a Marquis reagent is reacted with Rohypnol, a black/dark purple color may appear. Sulfuric acid may be used to catalyze the reaction, and formaldehyde in the reagent is oxidized to produce the color change.

Moreover, due to similarities in the chemical structures of Ketamine and Rohypnol, Ketamine reacts with a Mandelin or Marquis reagent in a similar way as Rohypnol. When a Mandelin reagent is used, Vanadate along with sulfuric acid catalyze the reaction, and the color change appears after Vanadate is oxidized. A brown/orange color will appear when Ketamine is reacted with the Mandelin reagent. When a Marquis reagent is used, formaldehyde is oxidized in the presence of Ketamine and sulfuric acid is used as a catalyst. The oxidation of formaldehyde in the presence of Ketamine produces a purple/black color.

When a Mandelin reagent or a Marquis reagent is used as the reagent, acid can be used as a catalyst to force the reaction to completion. Therefore, the acidity of a sample into which a testing strip is introduced may affect the amount of reaction product and in turn the intensity of the color observed.

The present invention may also include a dispenser for storing, transporting, and dispensing the testing strips. The dispenser includes a container and at least one of the testing strips comprising an elongated strip carrier and a reagent on the carrier. The reagent reacts with one of Rohypnol, Ketamine, GHB, GBL, and 1,4-butanediol to change color indicating the presence of Rohypnol, Ketamine, GHB, GBL, and 1,4-butanediol. The dispenser is air tight as well as water and light proof in order to protect the testing strips from outside environment contamination and to assure proper functioning of the testing strips. The dispenser also provides a convenient device such as a release mechanism that allows a person to access a testing strip quickly and easily when needed.

In a specific embodiment, the dispenser may be approximately 3 inches long, ¼ to 5/16 of an inch in width, and 1½ inches in height. It should be understood, however, that the dispenser may have any other dimensions. The dispenser merely must have a length and width that are at least as large as the length and width of the testing strips so that the testing strips are fittable in the dispenser.

The dispenser may be capable of storing up to 20 or more testing strips. The exact number of testing strips that the dispenser may hold is partially dependent on the size of the dispenser. The dispenser may dispense the testing strips one at a time. For example, the dispenser may dispense testing strips through an opening in the bottom of the dispenser. The opening may be opened when it is necessary to dispense a testing strip from the dispenser and closed to keep the dispenser sealed. To obtain a testing strip from the dispenser, a user simply slides a testing strip through the opening using a finger and/or thumb. The testing strips may be loaded into the dispenser by air pressure or spring loading such that when one testing strip is dispensed from the dispenser, the testing strip(s) remaining in the dispenser are advanced forward. The loading of the testing strips within the dispenser also keeps that testing strips from moving about the inside of the dispenser. The testing strips are thereby kept organized in the dispenser.

The dispenser may include a trademark logo on a front surface thereof and directions for use on an opposing back surface. Other product information may also be included on the outer surfaces of the dispenser.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A testing strip comprising:
an elongated strip carrier; and
a reagent on the carrier that reacts with one of Rohypnol, Ketamine, GHB, GBL, and 1,4-butanediol to change color indicating the presence of the said one of Rohypnol, Ketamine, GHB, GBL, and 1,4-butanediol.

2. The testing strip of claim 1, wherein said elongated strip carrier comprises plastic.

3. The testing strip of claim 1, wherein said elongated strip carrier comprises cellulose paper.

4. The testing strip of claim 1, wherein said reagent is impregnated in said elongated strip carrier.

5. The testing strip of claim 1, wherein said reagent is coated on said elongated strip carrier.

6. The testing strip of claim 1, wherein said reagent is adhered to said elongated strip carrier.

7. A dispenser for dispensing testing strips, said dispenser comprising:
a container; and
at least one testing strip comprising:
an elongated strip carrier; and
a reagent on the carrier that reacts with one of Rohypnol, Ketamine, GHB, GBL, and 1,4-butanediol to change color indicating the presence of the said one of Rohypnol, Ketamine, GHB, GBL, and 1,4-butanediol.

8. The dispenser of claim 7, further including a mechanism for releasing one of said at least one testing strip from said container.
